(19) United States
(12) Patent Application Publication
(10) Pub. No.: US 2012/0163806 A1
(43) Pub. Date: Jun. 28, 2012

(54) OPTICAL LINE TERMINAL DEVICE AND OPTICAL NETWORK DEVICE

(75) Inventors: HARK YOO, Gwangju (KR); Sung Chang KIM, Gwangju (KR); Geun Yong KIM, Gyeonggi-do (KR); Dongsoo LEE, Gwangju (KR); Mun Seob LEE, Daejeon (KR); Youngsuk LEE, Gwangju (KR); Sim-Kwon YOON, Gwangju (KR); Jong Deog KIM, Daejeon (KR)

(73) Assignee: Electronics and Telecommunications Research Institute, Daejeon (KR)

(21) Appl. No.: 13/237,339

(22) Filed: Sep. 20, 2011

(30) Foreign Application Priority Data
Dec. 22, 2010 (KR) 10-2010-0132701

(51) Int. Cl. H04B 17/00

(52) U.S. Cl. 398/25

(57) ABSTRACT

Disclosed is an optical line terminal device which includes a media access control (MAC) block configured to convert Ethernet packets and port identifiers into a downstream frame or an upstream frame into the Ethernet packets and the port identifiers; and a central processing unit (CPU) configured to control the MAC block, wherein the MAC block includes a traffic monitoring part which is configured to receive the port identifiers and to provide identifier information of an optical network device according to the port identifiers; and wherein the CPU is configured to generate a control frame for controlling a power supplied to the optical network device, according to identifier information of the optical network device.

### CROSS-REFERENCE TO RELATED APPLICATIONS

This application claims the benefits, under 35 U.S.C §119, of Korean Patent Application No. 10-2010-0132701 filed Dec. 22, 2010, the entirety of which is incorporated by reference herein.

### BACKGROUND

Exemplary embodiments relate to a passive optical network, and more particularly, relate to an optical line terminal device and an optical network device.

Many network architectures have been proposed to constitute a subscriber network. For example, there have been proposed xDSL (x-Digital Subscriber Line), HFC (Hybrid Fiber Coax), FTTB (Fiber To The Building), FTTC (Fiber To The Curb), FTTH (Fiber To The Home), etc. The FTTB, FTTC, and FTTH may be divided into an active FFTx (x=B, C, or H) realized by an active optical network (AON) and a passive FFTx realized by a passive optical network (PON).

The passive optical network may indicate a subscriber network constituting an optical line using passive components such as an optical multiplexer, a demultiplexer, a coupler, and the like. The passive optical network may have a point-to-multipoint structure in which a plurality of optical network terminals (or, units), that is, optical network terminals (ONTs) or optical network units (ONUs) share one optical line terminal (OLT) via passive elements. The passive optical network may be divided into APON (or, BPON), EPON, and GPON. Research on XGPON (10-giga GPON) being one of the GPON may be made actively.

In transceivers of optical network devices, a power can be consumed when valid data is not transmitted and received. If a specific optical network device reaches such a condition that it is switched to an inactive mode, an optical line terminal may control the specific optical network device to as to operate at an inactive state. Each optical network device may periodically judge switching into an inactive mode. Each optical network device may be switched into the inactive mode according to the judgment result. At this time, information indicating that an optical network device is switched into an inactive mode may be transmitted to an optical line terminal.

### SUMMARY

The inventive concept is related to monitor upward and downward traffics generated at an optical network device and to control a power supplied to the optical network device.

One aspect of embodiments of the inventive concept is directed to provide an optical line terminal device which comprises a media access control (MAC) block configured to convert Ethernet packets and port identifiers into a downstream frame or an upstream frame into the Ethernet packets and the port identifiers; and a central processing unit (CPU) configured to control the MAC block, wherein the MAC block includes a traffic monitoring part which is configured to receive the port identifiers and to provide identifier information of an optical network device according to the port identifiers; and wherein the CPU is configured to generate a control frame for controlling a power supplied to the optical network device, according to identifier information of the optical network device.

In this embodiment, the traffic monitoring part checks whether upstream and downstream traffics are generated from the optical network device, according to the port identifiers and provides the identifier information of the optical network device according to the checking result.

In this embodiment, the MAC block further comprises a frame converting part configured to receive the control frame and encapsulate the control frame, the encapsulated control frame being provided to the optical network device.

In this embodiment, the traffic monitoring part comprises a data storing circuit configured to store a mapping table associated with the port identifiers and the identifier information of the optical network device.

In this embodiment, the port identifiers are divided into downstream port identifiers converted into the downstream frame and upstream port identifiers extracted from the upstream frame.

In this embodiment, the traffic monitoring part comprises a count circuit configured to adjust a first count value according to the downstream port identifiers and a second count value according to the upstream port identifiers; and a detecting circuit configured to generate the control frame when one of the first and second count values reaches a threshold value.

In this embodiment, the traffic monitoring part further comprises a sensing circuit configured to check whether a downstream traffic is generated at the optical network device according to the downstream port identifiers and whether an upward traffic is generated at the optical network device according to the upstream port identifiers, and the count circuit adjusts the first count value according to whether the downstream traffic is generated and the second count value according to whether the upstream traffic is generated.

In this embodiment, the sensing circuit checks generation of the downstream and upstream traffics during a time and resets the checking result, and the count circuit adjusts the first and second count values according to the checking result.

Another aspect of embodiments of the inventive concept is directed to provide an optical network device which comprises a media access control (MAC) block configured to convert Ethernet packets and port identifiers into an upstream frame or to extract the Ethernet packets and the port identifiers from a downstream frame; a central processing unit (CPU) configured to control the MAC block; and a transmitting and receiving block configured to send the upstream frame to an external device and to receive the downstream frame from the external device, wherein the MAC block includes a traffic monitoring part which is configured to monitor the Ethernet packets and to generate a power management signal; and wherein the CPU is configured to control a power supplied to the transmitting and receiving block according to the power management signal.

In this embodiment, the traffic monitoring part generates the power management signal according to an input number of the Ethernet packets during a time.

In this embodiment, the Ethernet packets are divided into upstream Ethernet packets extracted from the downstream frame and downstream Ethernet packets converted into the upstream frame.

In this embodiment, the traffic monitoring part comprises a count circuit configured to adjust first and second count values according an input number of the upstream and downstream Ethernet packets during a time, respectively; and a detecting circuit configured to generate the power management signal according to the first and second count values.

In this embodiment, the detecting circuit generates the power management signal when either one of the first and second count values reaches a threshold value.

In this embodiment, the MAC block extracts Operation, Administration and Maintenance (OAM) frames from the downstream frame, and the traffic monitoring part monitors the OAM frames to generate the power management signal.

In this embodiment, the optical network device further comprises a plurality of user network interfaces configured to receive the Ethernet packets from an external device. The Ethernet packets include address information of the plurality of user network interfaces, respectively. The traffic monitoring part provides identifier information of at least one of the plurality of user network interfaces according to an input number of address information of the plurality of user network interfaces.

In this embodiment, the CPU interrupts a power supplied to at least one of the plurality of user network interfaces, according to identifier information of one of the plurality of user network interfaces.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram illustrating a passive optical network according to an exemplary embodiment of the inventive concept.

FIG. 2 is a block diagram illustrating an optical line terminal according to an exemplary embodiment of the inventive concept.

FIG. 3 is a block diagram illustrating a traffic monitoring part in FIG. 2.

FIG. 4 is a diagram illustrating a mapping table stored in a data storing circuit in FIG. 3.

FIG. 5 is a table illustrating the first count values and generation of downstream traffics of IDs of optical network devices.

FIG. 6 is a table illustrating the second count values and generation of upstream traffics of IDs of optical network devices.

FIG. 7 is a flowchart illustrating an operating method of a traffic monitoring part in FIG. 2 according to an exemplary embodiment of the inventive concept.

FIG. 8 is a block diagram illustrating an optical network device according to an exemplary embodiment of the inventive concept.

FIG. 9 is a block diagram illustrating a traffic monitoring part in FIG. 8.

FIG. 10 is a table illustrating a downstream traffic value stored in a downstream traffic register and the first count value stored in the first counter in FIG. 9.

FIG. 11 is a table illustrating an upstream traffic value stored in an upstream traffic register and the second count value stored in the second counter in FIG. 9.

FIG. 12 is a block diagram illustrating an optical network device including a traffic monitoring part monitoring downstream and upstream OAM frames.

### DETAILED DESCRIPTION

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

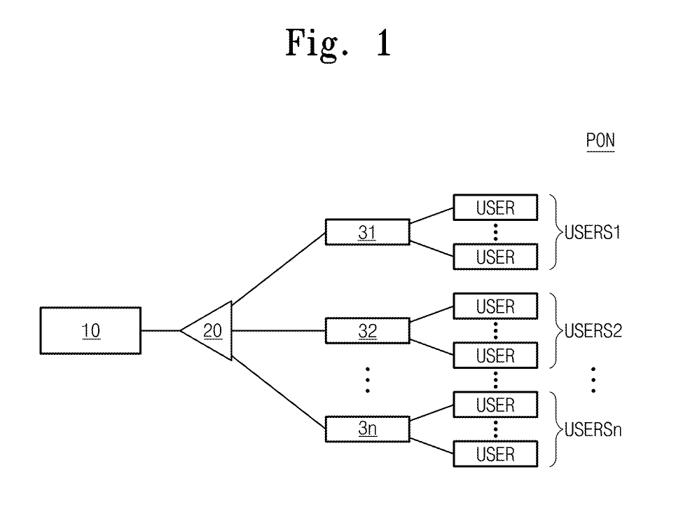

FIG. 1 is a block diagram illustrating a passive optical network according to an exemplary embodiment of the inventive concept. Referring to FIG. 1, a passive optical network (PON) may include an optical line terminal 10, a splitter 20, and a plurality of optical network devices 31 to 3n. The optical network devices 31 to 3n may be coupled with corresponding users USER1 to USERn, respectively.

The optical line terminal 10 may be located at a root of a tree structure. The optical line terminal 10 may be coupled with the splitter 20. The splitter 20 may distribute a downstream frame (not shown) transferred from the optical line terminal 10 into the optical network devices 31 to 3n. The splitter 20 may provide the optical line terminal 10 with upstream frames (not shown) transferred from the optical network devices 31 to 3n in a multiplexing manner.

The optical network devices 31 to 3n may be connected with the users USER1 to USERn via a user network interface (UNI) (not shown). For example, the first users USER1 may be coupled with the first optical network device 31 via the user network interfaces, respectively.

The optical line terminal 10 and the optical network devices 31 to 3n may transfer upstream and downstream frames. The upstream and downstream frames may be frames including information associated with voice and image data. The optical network devices 31 to 3n may provide an input downstream frame to the users USER1 to USERn, respectively. The optical network devices 31 to 3n may provide data output from the users USER1 to USERn to the optical line terminal 10 as an upstream frame. At this time, the users USER1 to USERn connected with the optical network devices 31 to 3n respectively may be various types of user network terminals capable of being used at the passive optical network PON.

The optical line terminal 10 and the optical network devices 31 to 3n may transfer upstream and downstream state frames. A state frame may be a frame for controlling an overall operation of the passive optical network PON including information associated with a power state, a connection with a passive optical network, etc.

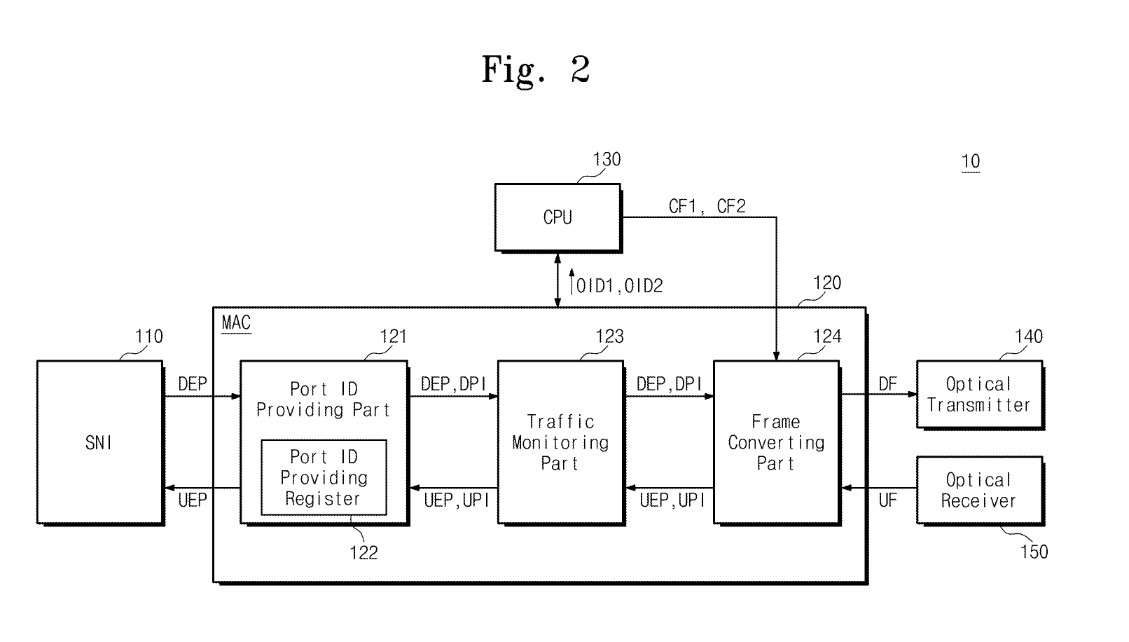

FIG. 2 is a block diagram illustrating an optical line terminal according to an exemplary embodiment of the inventive concept. Referring to FIG. 2, an optical line terminal 10 may include a service network interface (SNI) 110, a media access control (MAC) block 120, a CPU 130, an optical transmitter 140, and an optical receiver 150.

The service network interface 110 may receive downstream Ethernet packets DEP from a service provider (e.g., a broadcasting state) to provide the input downstream Ethernet packets DEP to a port ID providing part 121. The service network interface 110 may transfer upstream Ethernet packets UEP provided via the port ID providing part 121 to the service provider.

The downstream Ethernet packets DEP may include user address information, respectively. The user address information may be address information where a corresponding downstream Ethernet packet DEP is to be transmitted. For example, each downstream Ethernet packet may include ID information of one of user network interfaces connected with optical network devices 31 to 3n. In an exemplary embodiment, each of the downstream Ethernet packets DEP may include a MAC address or virtual LAN (VLAN) address information.

The MAC block 120 may receive the downstream Ethernet packets DEP, and may encapsulate the input downstream Ethernet packets DEP to generate a downstream frame DF.

The MAC block 120 may receive an upstream frame UF, and may convert the input upstream frame UP into upstream Ethernet packets UEP to transfer the upstream Ethernet packets to the service network interface 110.

The MAC block 120 may include a port ID providing part 121, a traffic monitoring part 123, and a frame converting part 124. The port ID providing part 121 may include a port ID providing register 122, which is configured to store a mapping table associated with user address information and port IDs.

Each of the port IDs may indicate any point within a passive optical network PON in FIG. 1. In an exemplary embodiment, each of the port IDs may correspond to one of optical network devices 31 to 3n or one of user network interfaces connected with the optical network devices 31 to 3n.

Below, port IDs corresponding to user address information included in the downstream Ethernet packets DEP may be referred to as downstream port IDs DPI, and port IDs corresponding to user address information included in the upstream Ethernet packets UEP may be referred to as upstream port IDs UPI.

The port ID providing part 121 may provide downstream port IDs DPI corresponding to user address information included in the downstream Ethernet packets DEP, respectively. The port ID providing part 121 may search downstream port IDs corresponding to user address information respectively from the mapping table stored in the port ID providing register 121. The downstream port IDs DPI and the downstream Ethernet packets DEP may be sent to the traffic monitoring part 123.

The traffic monitoring part 123 may receive the downstream port IDs DPI and the downstream Ethernet packets DEP. The traffic monitoring part 123 may search an optical network device, which does not receive a downstream frame DF, based upon the downstream port IDs DPI, and may generate ID information OID1 corresponding to the searched optical network device. That is, the traffic monitoring part 123 may search ID information OID1 (hereinafter, referred to as the first ID information) of the optical network device not generating a downstream traffic, based upon the downstream port ID DPI.

The traffic monitoring part 123 may receive the upstream Ethernet packets UEP and the upstream port IDs UPI from the frame converting part 124. The traffic monitoring part 123 may search an optical network device not generating an upstream frame UF using the upstream port IDs UPI, and may generate ID information OID2 (hereinafter, referred to as to the second ID information) corresponding to the searched optical network device. That is, the traffic monitoring part 123 may search the second ID information OID2 associated with an optical network device not generating an upstream traffic, based upon the upstream port IDs UPI.

The frame converting part 124 may generate a downstream frame DF based upon the downstream Ethernet packets DEP and the downstream port IDs DPI. The frame converting part 124 may generate the upstream Ethernet packets UEP and the upstream port IDs UPI, based upon an upstream frame UF received from the optical receiver 150.

The CPU 130 may control an overall operation of the MAC block 120. The CPU 130 may receive the first or second ID information OID1 or OID2. The CPU 130 may generate the first control frame CF1 for controlling a power supplied to an optical network device corresponding to the first ID information OID1. The CPU 130 may generate the second control frame CF2 for controlling a power supplied to an optical network device corresponding to the second ID information OID2.

The first and second control frames CF1 and CF2 may be sent to the frame converting part 124. In an exemplary embodiment, the first and second control frames CF1 and CF2 may be configured like an Operation, Administration, and Maintenance (OAM) frame. The OAM frame may be a frame for operating, administrating, and maintaining a passive optical network 100 in FIG. 1. In an exemplary embodiment, the OAM frame may be formed of an ONT Management Channel Interface OMCI.

If receiving one of the first and second control frames CF1 and CF2, the frame converting part 124 may encapsulate the input control frame to generate a downstream frame DF. The downstream frame DF based on the first or second control frames CF1 or CF2 may be transmitted to an optical network device corresponding to the first or second control frames CF1 or CF2 via the optical transmitter 140. When receiving the downstream frame DF, an optical network device may be inactivated.

In an exemplary embodiment, an optical network device receiving the downstream frame DF based on the first control frame CF1 may operate at a cyclic sleep mode. An optical network device receiving the downstream frame DF based on the second control frame CF2 may operate at a dozing sleep mode.

An optical transmitter and an optical receiver of an optical network device operating at the cyclic sleep mode may periodically operate at on and off states. When an optical network device operates at the dozing sleep mode, its optical transmitter may periodically operate at on and off states, and its optical receiver may operate at an on state.

In an exemplary embodiment, the frame converting part 124 may support a transfer manner according to an ATM (Asynchronous Transfer Mode) or GEM (GPON Encapsulation Method) mode. That is, the frame converting part 124 may simultaneously support not only a cell-based transfer manner (ATM) having a fixed unit, but also a GEM mode supporting a transfer on an Ethernet packet having a variable size.

In an exemplary embodiment, the frame converting part 124 may generate a GEM frame based upon the downstream Ethernet packets DEP and the downstream port IDs DPI. The frame converting part 124 may encapsulate the GEM frame into a GTC (GPON Transmission Convergence) frame. The frame converting part 124 may encapsulate one of the first and second control frames CF1 and CF2 into a GTC frame. The frame converting part 124 may encapsulate the GTC frame into a GPON (GPON Physical Frame) frame. That is, the frame converting part 124 may configure the downstream frame DF to the GPON frame.

The upstream frame UF may be provided to the frame converting part 124 via the optical receiver 150. In an exemplary embodiment, the upstream frame UF may be configured like the GPON frame. The frame converting part 124 may convert the upstream frame UF into the upstream Ethernet packets UEP and the upstream port IDs UPI.

In an exemplary embodiment, the frame converting part 124 may convert the upstream frame UF into the GTC frame. The frame converting part 124 may convert the GTC frame into a GEM frame. Based upon the GEM frame, the frame converting part 124 may generate the upstream Ethernet packets UEP and the upstream port IDs UPI. The upstream Ethernet packets UEP and the upstream port IDs UPI may be provided to the traffic monitoring part 123.

In the event that upstream and downstream traffics of optical network devices 31 to 3n in FIG. 1 are detected outside the optical line terminal 10, upstream and downstream frames UF and DF and upstream and downstream state frames (not shown) may be divided. Upstream and downstream frames may be monitored. According to an exemplary embodiment of the inventive concept, the traffic monitoring part 123 may include the MAC block 120. An optical line terminal according to an exemplary embodiment of the inventive concept may detect upstream and downstream traffics of optical network devices 31 to 3n according to port IDs DPI and UPI without a detecting means on a separate state frame (not shown).

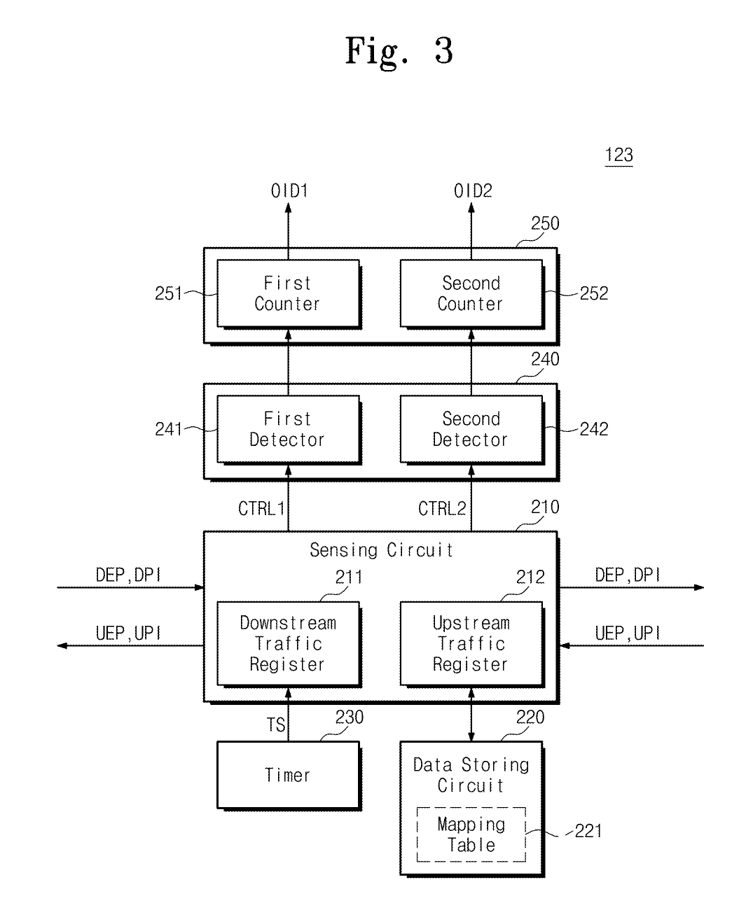

FIG. 3 is a block diagram illustrating a traffic monitoring part in FIG. 2. Referring to FIG. 3, a traffic monitoring part 123 may include a sensing circuit 210, a data storing circuit 220, a timer 230, a count circuit 240, and a detecting circuit 250.

The sensing circuit 210 may be coupled with the data storing circuit 220, the timer 230, and the count circuit 240. The sensing circuit 210 may receive a downstream Ethernet packet DEF and a downstream port ID DPI. When receiving the downstream port ID DPI, the sensing circuit 210 may receive ID information of optical network devices corresponding respectively to downstream port IDs DPI from a mapping table 221 stored in the data storing circuit 220. According to the ID information of the optical network devices, the sensing device 210 may store information associated with whether downstream traffics are generated from optical network devices 31 to 3n in FIG. 1, in a downstream traffic register 211.

The sensing circuit 210 may receive an upstream Ethernet packet UEF and an upstream port ID UPI. The sensing circuit 210 may search the mapping table 221 of the data storing circuit 220. The sensing circuit 210 may receive ID information of optical network devices corresponding to upstream Ethernet packets UEF, respectively.

According to the input ID information of the optical network devices, the sensing device 210 may store information associated with whether upstream traffics are generated from optical network devices 31 to 3n in FIG. 1, in an upstream traffic register 212.

The sensing circuit may receive time information from the timer 230. The timer 230 may send a timing signal TS every time.

In response to the timing signal TS, the sensing circuit 210 may generate the first and second control signals CTRL1 and CTRL2 according to sensing results stored in the upstream and downstream traffic registers 211 and 212, respectively. After generation of the first and second control signals CTRL1 and CTRL2, the sensing circuit 210 may reset the downstream and upstream traffic registers 211 and 212 such that information associated with generation of stored upstream and downstream traffics is reset.

The data storing circuit 220 may store the mapping table 221 associated with port IDs and ID information of an optical network device. The data storing circuit 220 may provide ID information of optical network devices corresponding to downstream port IDs DPI and upstream port IDs UPI.

The count circuit 240 may include the first and second counters 241 and 242. The first and second counters 241 and 242 may receive the first and second control signals CTRL1 and CTRL2, respectively. The first and second counters 241 and 242 may count in response to the first and second control signals CTRL1 and CTRL2, respectively.

The detecting circuit 250 may include the first and second detectors 251 and 252. The first detector 251 may detect whether a count value of the first counter 241 reaches a threshold value. The second detector 252 may detect whether a count value of the second counter 242 reaches a threshold value. When a count value of the first counter 241 reaches the threshold value, the first detector 251 may generate the first ID information OID1. When a count value of the second counter 242 reaches the threshold value, the second detector 252 may generate the second ID information OID2.

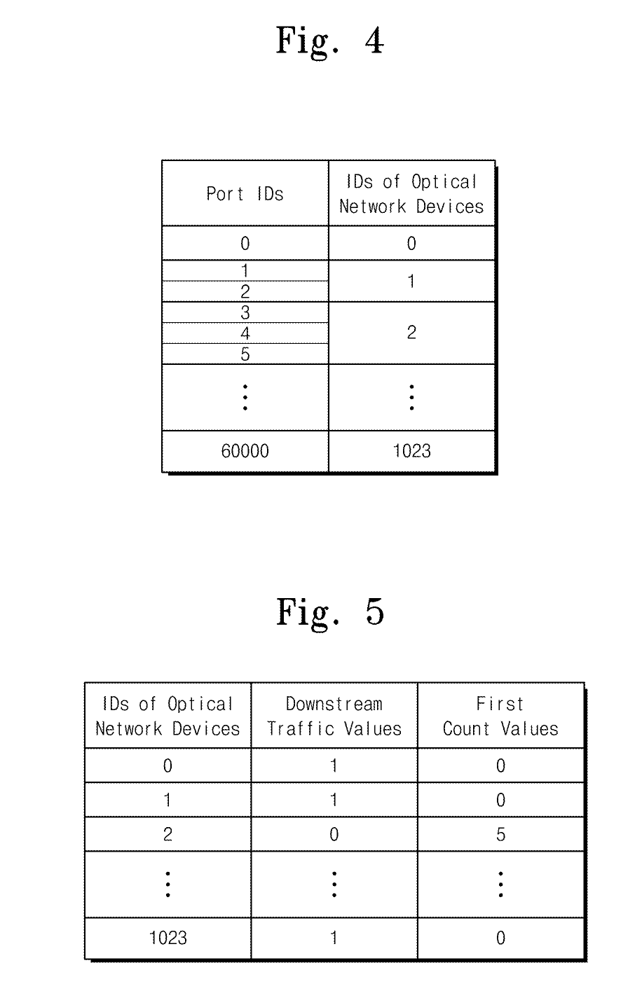

FIG. 4 is a diagram illustrating a mapping table stored in a data storing circuit in FIG. 3. Port IDs may correspond to one of IDs of optical network devices 31 to 3n.

FIG. 5 is a table illustrating the first count values and generation of downstream traffics of IDs of optical network devices. In FIG. 5, downstream traffic values may be values stored in a downstream traffic register 211 in FIG. 3. The first count values may be values counted by the first counter in FIG. 3.

Referring to FIGS. 3 to 5, a sensing circuit 210 may search IDs of optical network devices corresponding to downstream port IDs DPI from a mapping table 221. The sensing circuit 210 may change downstream traffic values corresponding respectively to IDs of searched optical network devices into ‘1’. The sensing circuit 210 may generate the first control signal CTRL1 to change the first count value corresponding to an ID of a searched optical network device into ‘0’. In the event that a downstream traffic value was previously set to ‘1’, the sensing circuit 210 may maintain a traffic value.

It is assumed that a downstream frame DF is transferred every 125 μs. Desirably, a timer 230 may generate a timing signal TS every 125 μs. The sensing circuit 210 may update downstream traffic values according to downstream port IDs DPI received before the timing signal TS is received. In response to the timing signal TS, the sensing circuit 210 may control the first counter 241 using downstream traffic values.

That a downstream traffic value is ‘1’ may mean that a downstream traffic is generated from an optical network device corresponding to the value during 125 μs. That a downstream traffic value is ‘0’ may mean that a downstream traffic is not generated from an optical network device corresponding to the value during 125 μs. The sensing circuit 210 may generate the first control signal CTRL1 to increase the first count values corresponding respectively to IDs of optical network devices each having a traffic value of ‘0’, by ‘1’. Afterwards, the sensing circuit 210 may reset all traffic values to ‘0’. During the following time of 125 μs, the sensing circuit 210 may operate the same as described above.

The first detector 251 may receive the first count values. In the event that at least one of the first count values reaches a predetermined threshold value, the first detector 251 may generate the first ID information OID1 being ID information of an optical network device corresponding to a count value reaching the threshold value.

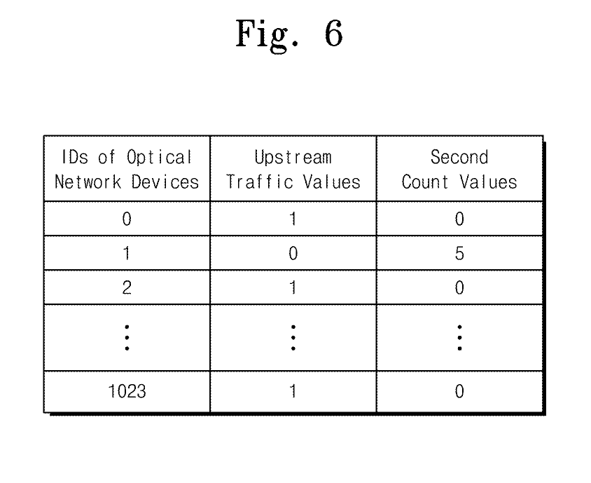

FIG. 6 is a table illustrating the second count values and generation of upstream traffics of IDs of optical network devices. In FIG. 6, downstream traffic values may be values stored in a downstream traffic register 211 in FIG. 3. The first count values may be values counted by the first counter in FIG. 3. An operation of sensing upstream traffics will be described the same as an operation of sensing downstream traffics.

Referring to FIGS. 3, 4, and 6, if upstream port IDs UPI are received, a sensing circuit 210 may search IDs of optical network devices corresponding respectively to upstream ports IDs UPI from a mapping table 221. The sensing circuit 210 may change upstream traffic values corresponding respectively to IDs of searched optical network devices into ‘1’. The sensing circuit 210 may generate the second control signal CTRL2 to convert the second count values corresponding respectively to IDs of the searched optical network devices into ‘0’. If an upstream traffic value was previously set to ‘1’, the sensing circuit 210 may maintain an upstream traffic value.

The sensing circuit 210 may generate the second control signal CTRL2 in response to the timing signal TS, so that the second count values corresponding respectively to IDs of optical network devices are adjusted. In response to the timing signal TS, the sensing circuit 210 may increase the second count values corresponding respectively to optical network devices each having an upstream traffic value of ‘0’, by ‘1’.

If at least one of the second count values reaches a predetermined threshold value, the second detector 252 may generate the second ID information OID2 being ID information of an optical network device corresponding to a count value reaching the threshold value.

Unlike description of FIG. 6, the first count values may increase when each downstream traffic value is ‘1’, and an ID of an optical network device corresponding to a count value, being larger than a threshold voltage, of the first count values may be provided to a CPU 130. Likewise, the second count values may increase when each upstream traffic value is ‘1’, and an ID of an optical network device corresponding to a count value, being larger than a threshold voltage, of the second count values may be provided to the CPU 130. Based upon ID information of an optical network device, the CPU 130 may generate an OAM frame such that an optical network device operating at an inactive state operates at an active state.

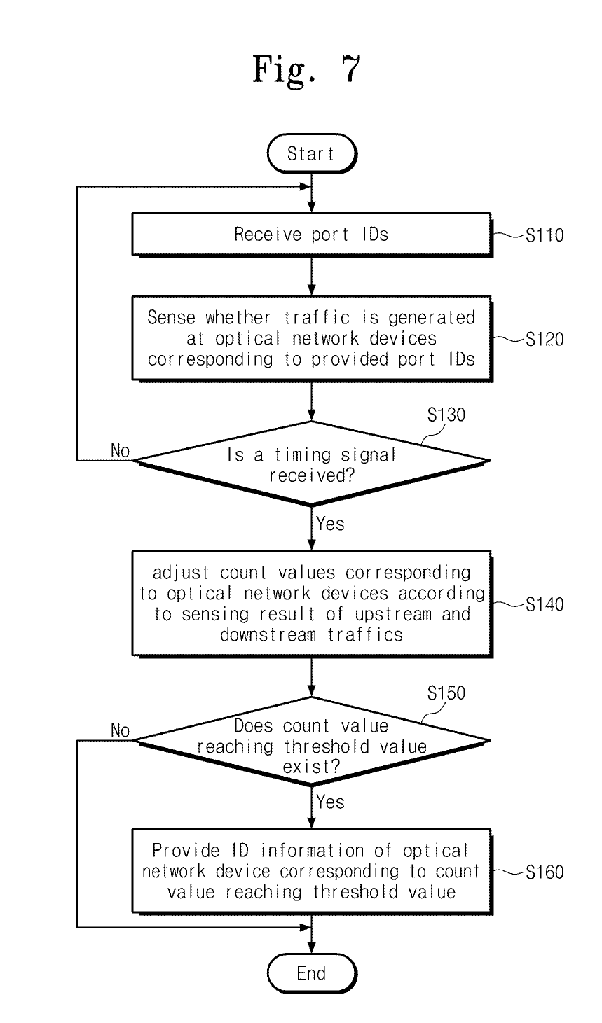

FIG. 7 is a flowchart illustrating an operating method of a traffic monitoring part in FIG. 2 according to an exemplary embodiment of the inventive concept. Referring to FIGS. 3 to 7, in operation S110, downstream or upstream port IDs DPI or UPI may be provided to a traffic monitoring part 123.

In operation S120, the traffic monitoring part 123 may sense whether downstream or upstream traffics are generated from optical network devices corresponding to the downstream or upstream port IDs DPI or UPI, respectively. For example, the traffic monitoring part 123 may store port IDs and IDs of optical network devices in a mapping table 221 including mapping information of port IDs and IDs of optical network devices IDs. The traffic monitoring part 123 may search IDs of optical network devices corresponding to downstream or upstream port IDs DPI or UPI according to the mapping table 221.

In operation S130, if no timing signal TS is received, the method returns to operation S110. If the timing signal TS0 is received, the method may proceed to operation S140.

In operation S140, count values corresponding respectively to optical network devices may be adjusted according to sensing results of downstream or upstream traffics. In an exemplary embodiment, the first count value corresponding to an optical network device where a downstream traffic is generated may be changed into ‘0’. The first count value corresponding to an optical network device where no downstream traffic is generated may increase by ‘1’. In an exemplary embodiment, the second count value corresponding to an optical network device where an upstream traffic is generated may be changed into ‘0’. The second count value corresponding to an optical network device where no upstream traffic is generated may increase by ‘1’.

In operation S150, whether count values corresponding respectively to optical network devices reach a threshold value may be judged. If a count value reaching the threshold value exists, in operation S160, the traffic monitoring part 123 may generate an ID of an optical network device corresponding to a count value reaching the threshold value. If no count value reaching the threshold value exists, an ID of an optical network device may not be provided.

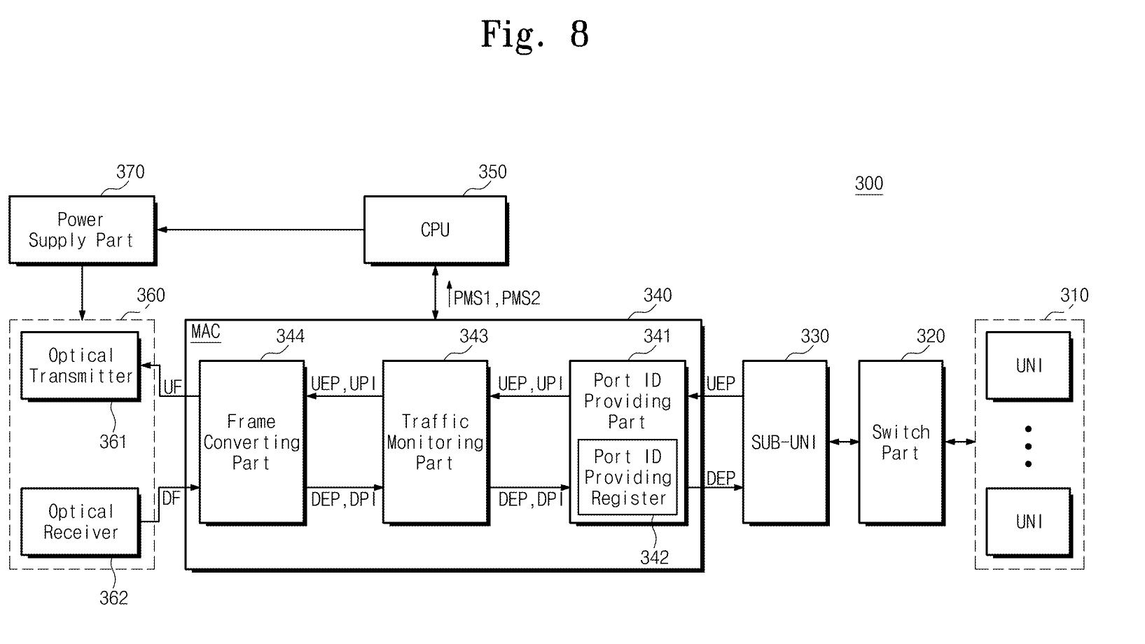

FIG. 8 is a block diagram illustrating an optical network device according to an exemplary embodiment of the inventive concept. Optical network devices 31 to 3n in FIG. 2 may be configured the same as an optical network device 300 in FIG. 8.

The optical network device 300 may include user network interfaces 310, a switch part 320, a sub-user network interface 330, an MAC block 340, a CPU 350, a transmitting and receiving block 360, and a power supply part 370.

The user network interfaces 310 may receive upstream Ethernet packets UEP from users (refer to FIG. 1), respectively. The user network interfaces 310 may transmit downstream Ethernet packets DEP to users, respectively. In an exemplary embodiment, each of the user network interfaces 310 may be formed of an interface standardized protocol between a user terminal and a passive optical network PON.

The switch part 320 may multiplex the upstream Ethernet packets UEP received from the user network interfaces 310 to be sent to the sub-user network interface 330. The switch part 320 may transfer downstream Ethernet packets DEP from the sub-user network interface 330 to one of the user network interfaces 310.

The sub-user network interface 330 may transfer upstream Ethernet packets UEP received from the switching part 320 to a port ID providing part 341. The sub-user network interface 330 may transfer the downstream Ethernet packets DEP received from the port ID providing part 341 to the switch part 320. In an exemplary embodiment, like the user network interfaces 310, the sub-user network interface 330 may be formed of an interface standardized protocol between a user terminal and a passive optical network PON.

The MAC block 340 may include the port ID providing part 341, a traffic monitoring part 343, and a frame converting part 344. The port ID providing part 341 and the frame converting part 344 may be configured the same as those 121 and 124 in FIG. 2, and description thereof is thus omitted.

The traffic monitoring part 343 may monitor the upstream and downstream Ethernet packets UEP and DEP. The traffic monitoring part 343 may generate the first and second power management signals PMS1 and PMS2 whether the upstream and downstream Ethernet packets UEP and DEP are received.

The CPU 350 may control an overall operation of the MAC block 340. The CPU 350 may control the power supply part 370 according to the first and second power management signals PMS1 and PMS2. For example, in response to the first power management signal PMS1, the CPU 350 may control the power supply part 370 such that an optical transmitter 361 and an optical receiver 362 periodically operate at an on/off state. For example, in response to the second power management signal PMS2, the CPU 350 may control the power supply part 370 such that the optical receiver 362 periodically operates at an on/off state.

The transmitting and receiving block 360 may include the optical transmitter 361 and the optical receiver 362. The transmitting and receiving block 360 may be supplied with a power from the power supply part 370. An upstream frame UF transmitted via the optical transmitter 361 may be sent to an optical line terminal 10 in FIG. 1 via a splitter 20 in FIG. 1. A downstream frame DF generated from the optical line terminal 10 may be received via the optical receiver 362 via the splitter 20.

In an exemplary embodiment, in the event that a downstream frame DF where the first control frame CF1 (refer to FIG. 2) is encapsulated is received, the frame converting part 344 may generate the first control frame CF1 from the downstream frame DF. The first control frame CF1 may be sent to the CPU 350. In response to the first control frame CF1, the CPU 350 may control the power supply part 370 such that the optical transmitter 361 and the optical receiver 362 periodically operate at an on/off state.

In an exemplary embodiment, in the event that a downstream frame DF where the second control frame CF2 (refer to FIG. 2) is encapsulated is received, the frame converting part 344 may generate the second control frame CF2 from the downstream frame DF. In response to the second control frame CF2, the CPU 350 may control the power supply part 370 such that the optical transmitter 361 periodically operates at an on/off state.

According to an exemplary embodiment of the inventive concept, the traffic monitoring block 343 may include the MAC block 340. An optical line terminal according to an exemplary embodiment of the inventive concept may detect upstream and downstream traffics of the optical network device 300 according to port IDs DPI and UPI without a detecting means on a separate state frame (not shown).

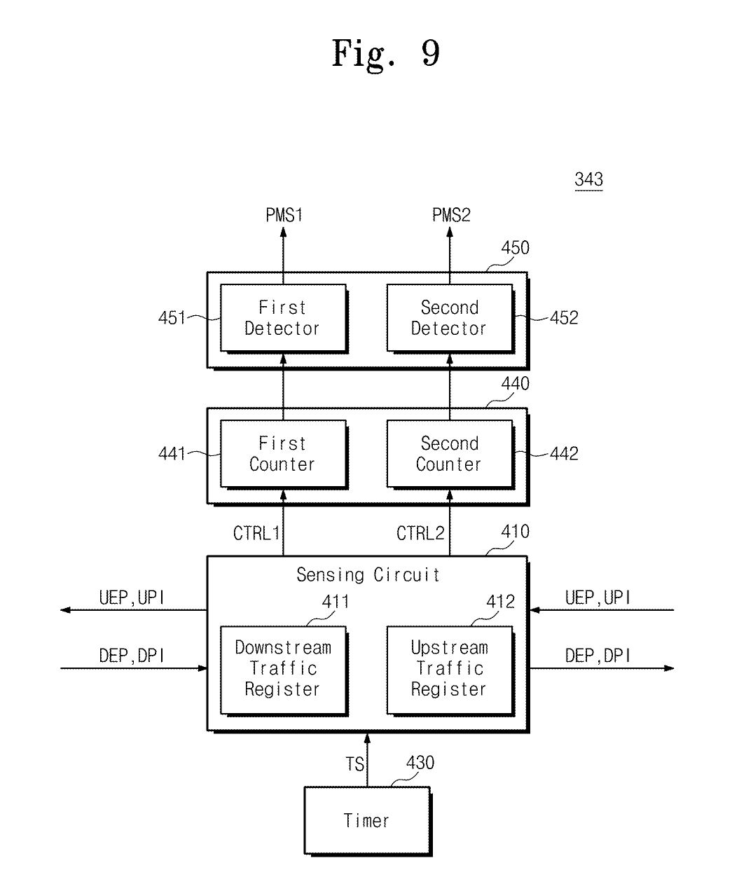

FIG. 9 is a block diagram illustrating a traffic monitoring part in FIG. 8. Referring to FIG. 9, a traffic monitoring part 343 may include a sensing circuit 410, a timer 430, a count circuit 440, and a detecting circuit 450.

The sensing circuit 410 may receive a downstream Ethernet packet DEF and a downstream port ID DPI. The sensing circuit 410 may include a downstream traffic register 411 and an upstream traffic register 412.

When receiving the downstream Ethernet packets DEF, the sensing circuit 410 may store information indicating that the downstream Ethernet packets DEF are received, in the downstream traffic register 411. When receiving the upstream Ethernet packets UEF, the sensing circuit 410 may store information indicating that the upstream Ethernet packets DEF are received, in the upstream traffic register 412. That is, the downstream and upstream registers 411 and 412 may store information associated with downstream and upstream traffics within an optical network device 300 are generated.

The sensing circuit 410 may receive a timing signal TS from the timer 430 every time. In response to the timing signal TS, the sensing circuit 410 may generate the first and second control signals CTRL1 and CTRL2. The sensing circuit 410 may generate the first control signal CTRL1 according to information associated with generation of the downstream traffic stored in the downstream traffic register 411. The sensing circuit 410 may generate the second control signal CTRL2 according to information associated with generation of the upstream traffic stored in the upstream traffic register 412. After generation of the first and second control signals CTRL1 and CTRL2, the sensing circuit 410 may reset the downstream and upstream traffic registers 211 and 212 such that information associated with generation of stored upstream and downstream traffics is reset.

The count circuit 440 may include the first and second counters 441 and 442. The first and second counters 441 and 442 may count in response to the first and second control signals CTRL1 and CTRL2, respectively.

The detecting circuit 450 may include the first and second detectors 451 and 452. The first detector 451 may detect whether a count value of the first counter 441 reaches a threshold value. The second detector 452 may detect whether a count value of the second counter 442 reaches a threshold value. When a count value of the first counter 441 reaches the threshold value, the first detector 451 may generate the first power management signal PMS1. When a count value of the second counter 442 reaches the threshold value, the second detector 452 may generate the second power management signal PMS2.

The downstream and upstream Ethernet packets DEP and UEP may include user address information corresponding to user network interfaces 310. In an exemplary embodiment, the downstream and upstream Ethernet packets DEP and UEP may include MAC address information or VLAN address information, respectively. The traffic monitoring block 343 may monitor whether downstream and upstream traffics are generated at the user network interfaces 310, based upon the number by which user address information is provided. At this time, the downstream traffic register 411 may store information associated with generation of a downstream traffic of each user network interface 310, and the upstream traffic register 412 may store information associated with generation of an upstream traffic of each user network interface 310. The sensing circuit 410 may adjust count values of the first counter 441 by generating the first control signal CTRL1 according to information stored in the downstream traffic register 411. The sensing circuit 410 may adjust count values of the second counter 442 by generating the second control signal CTRL2 according to information stored in the upstream traffic register 412. That is, the first and second counters 441 and 442 may store count values corresponding to the user network interfaces 310, respectively. ID values of the user network interfaces 310 may be provided to a CPU 350 according to count values stored in the first and second counters 441 and 442. The CPU 350 may adjust a power supplied to the user network interfaces 310.

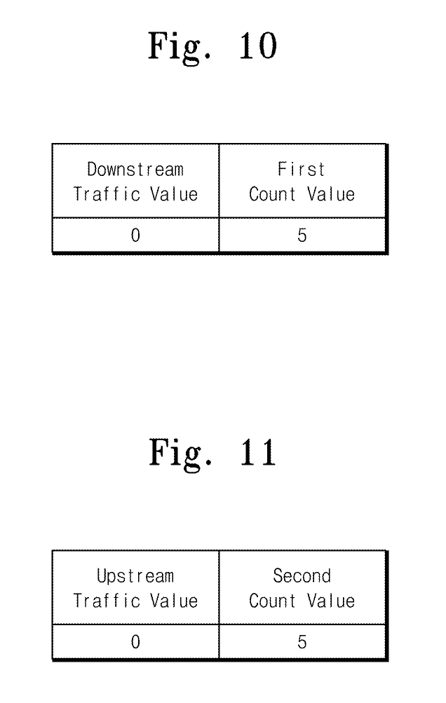

FIG. 10 is a table illustrating a downstream traffic value stored in a downstream traffic register and the first count value stored in the first counter in FIG. 9. When receiving downstream Ethernet packets DEF, a sensing circuit 410 may change a downstream traffic value to ‘1’. The sensing circuit 410 may change the first count value stored in the first counter 411 into ‘0’ by sending the first control signal CTRL1. If downstream Ethernet packets DEF are not received until a timing signal TS is received, a downstream traffic value may be maintained at ‘0’.

If a downstream traffic value is ‘0’ at an input of the timing signal TS, the sensing circuit 410 may increase the first count value by ‘1’ by sending the first control signal CTRL1. And then, the downstream traffic value may be reset. The above-described operation may be repeated every TS-based period. When the first count value reaches a threshold value, the first detector 451 may generate the first power management signal PMS1.

FIG. 11 is a table illustrating an upstream traffic value stored in an upstream traffic register and the second count value stored in the second counter in FIG. 9. When receiving upstream Ethernet packets UEF, a sensing circuit 410 may change an upstream traffic value to ‘1’. At this time, the second count value stored in the second counter 412 may be changed into ‘0’.

If an upstream traffic value is ‘0’ at an input of the timing signal TS, the sensing circuit 410 may increase the second count value by ‘1’ by sending the second control signal CTRL2. When the second count value reaches a threshold value, the second detector 452 may generate the second power management signal PMS2. After sending the second control signal CTRL2, the sensing circuit 410 may reset the upstream traffic value.

Unlike description of FIGS. 10 and 11, the sensing circuit 410 may increase downstream and upstream Ethernet packets DEF and UEF by ‘1’ whenever downstream and upstream Ethernet packets DEF and UEF are received. When receiving the timing signal TS, the sensing circuit 410 may increase the first count value by ‘1’ by sending the first control signal CTRL1 if the downstream traffic value is ‘0’. When receiving the timing signal TS, the sensing circuit 410 may increase the second count value by ‘1’ by sending the second control signal CTRL2 if the upstream traffic value is ‘0’.

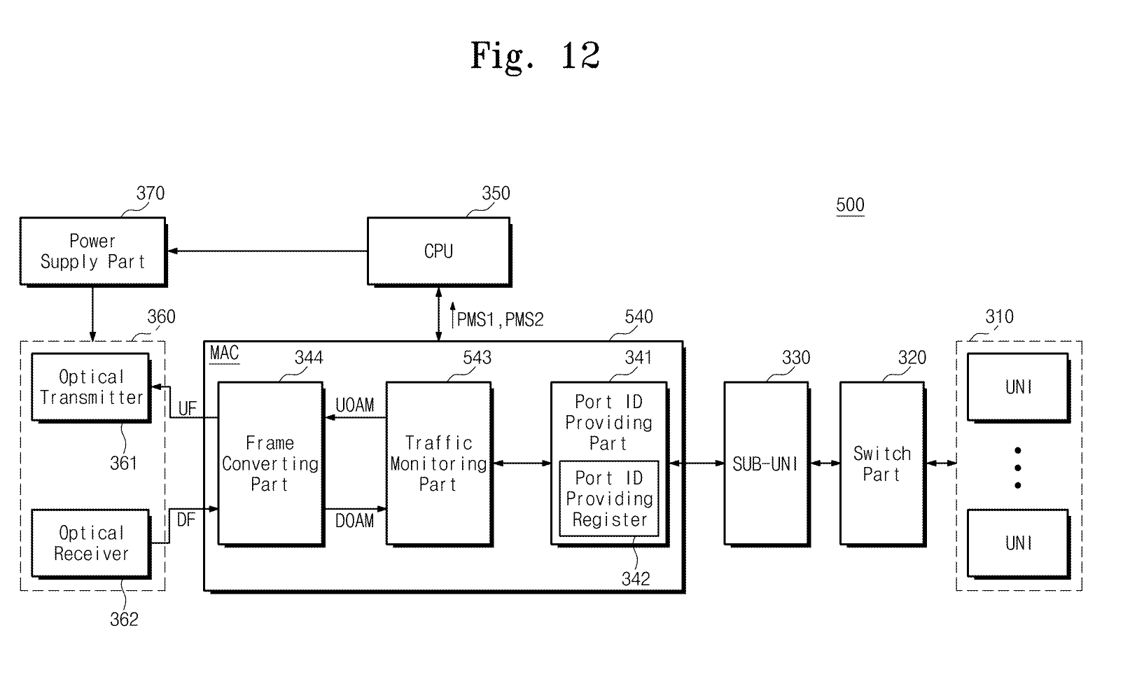

FIG. 12 is a block diagram illustrating an optical network device including a traffic monitoring part monitoring downstream and upstream OAM frames. Referring to FIG. 12, a frame converting part 344 may generate downstream OAM frames DOAM by converting a downstream frame DF. The frame converting part 344 may generate an upstream frame UF by encapsulating upstream OAM frames UOAM.

The downstream frames DOAM may be transmitted to a CPU 350 via a traffic monitoring part 543. The upstream OAM frames UOAM may be provided from the CPU 350, and may be sent to the frame converting part 344 via the traffic monitoring part 543. In an exemplary embodiment, the CPU 350 may operate, administrate, and maintain an optical network device 500 based upon the downstream OAM frames DOAM. In an exemplary embodiment, in the event that operation, administration, and maintenance are independently made by the optical network device 500, the CPU 350 may generate the upstream OAM frames UOAM.

The traffic monitoring part 543 may be identical to that 343 in FIG. 8 except that the downstream and upstream OAM frames DOAM and UOAM are monitored. That is, the traffic monitoring part 543 may generate the first and second power management signals PMS1 and PMS2 according to whether the downstream and upstream OAM frames DOAM and UOAM are received.

According to an exemplary embodiment of the inventive concept, a traffic monitoring block may include a MAC block. Accordingly, an optical line terminal according to an exemplary embodiment of the inventive concept may detect upstream and downstream traffics of optical network devices according to port IDs without a detecting means on a separate state frame (not shown).

With the above description, it is possible to monitor upstream and downstream traffics generated from an optical network device and to control a power supplied to the optical network device.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. An optical line terminal device comprising:
a media access control (MAC) block configured to convert Ethernet packets and port identifiers into a downstream frame or an upstream frame into the Ethernet packets and the port identifiers; and
a central processing unit (CPU) configured to control the MAC block,
wherein the MAC block includes a traffic monitoring part which is configured to receive the port identifiers and to provide identifier information of an optical network device according to the port identifiers; and
wherein the CPU is configured to generate a control frame to control a power supplied to the optical network device, according to identifier information of the optical network device.

2. The optical line terminal device of claim 1, wherein the traffic monitoring part checks whether upstream and downstream traffics are generated from the optical network device, according to the port identifiers and provides the identifier information of the optical network device according to the checking result.

3. The optical line terminal device of claim 1, wherein the MAC block further comprises:
a frame converting part configured to receive the control frame and encapsulate the control frame, the encapsulated control frame being provided to the optical network device.

4. The optical line terminal device of claim 1, wherein the traffic monitoring part comprises:
a data storing circuit configured to store a mapping table associated with the port identifiers and the identifier information of the optical network device.

5. The optical line terminal device of claim 1, wherein the port identifiers are divided into downstream port identifiers converted into the downstream frame and upstream port identifiers extracted from the upstream frame.

6. The optical line terminal device of claim 5, wherein the traffic monitoring part comprises:
a count circuit configured to adjust a first count value according to the downstream port identifiers and a second count value according to the upstream port identifiers; and
a detecting circuit configured to generate the control frame when one of the first and second count values reaches a threshold value.

7. The optical line terminal device of claim 6, wherein the traffic monitoring part further comprises:
a sensing circuit configured to check whether a downstream traffic is generated at the optical network device according to the downstream port identifiers and whether an upward traffic is generated at the optical network device according to the upstream port identifiers, and
wherein the count circuit adjusts the first count value according to whether the downstream traffic is generated and the second count value according to whether the upstream traffic is generated.

8. The optical line terminal device of claim 7, wherein the sensing circuit checks generation of the downstream and upstream traffics during a time and resets the checking result, and the count circuit adjusts the first and second count values according to the checking result.

9. An optical network device comprising:
a media access control (MAC) block configured to convert Ethernet packets and port identifiers into an upstream frame or to extract the Ethernet packets and the port identifiers from a downstream frame;
a central processing unit (CPU) configured to control the MAC block; and
a transmitting and receiving block configured to send the upstream frame to an external device and to receive the downstream frame from the external device,
wherein the MAC block includes a traffic monitoring part which is configured to monitor the Ethernet packets and to generate a power management signal; and
wherein the CPU is configured to control a power supplied to the transmitting and receiving block according to the power management signal.

10. The optical network device of claim 9, wherein the traffic monitoring part generates the power management signal according to an input number of the Ethernet packets during a time.

11. The optical network device of claim 9, wherein the Ethernet packets are divided into upstream Ethernet packets extracted from the downstream frame and downstream Ethernet packets converted into the upstream frame.

12. The optical network device of claim 11, wherein the traffic monitoring part comprises:
a count circuit configured to adjust first and second count values according an input number of the upstream and downstream Ethernet packets during a time, respectively; and
a detecting circuit configured to generate the power management signal according to the first and second count values.

13. The optical network device of claim 12, wherein the detecting circuit generates the power management signal when either one of the first and second count values reaches a threshold value.

14. The optical network device of claim 9, wherein the MAC block extracts Operation, Administration and Maintenance (OAM) frames from the downstream frame, and the traffic monitoring part monitors the OAM frames to generate the power management signal.

15. The optical network device of claim 9, further comprising:
a plurality of user network interfaces configured to receive the Ethernet packets from an external device;
wherein the Ethernet packets include address information of the plurality of user network interfaces, respectively; and
wherein the traffic monitoring part provides identifier information of at least one of the plurality of user network interfaces according to an input number of address information of the plurality of user network interfaces.

16. The optical network device of claim 15, wherein the CPU interrupts a power supplied to at least one of the plurality of user network interfaces, according to identifier information of one of the plurality of user network interfaces.
